(19) United States
(12) Patent Application Publication
(10) Pub. No.: US 2003/0120607 A1
(43) Pub. Date: Jun. 26, 2003

(54) E-receipt verification system and method

(75) Inventor: Tony Piotrowski, Wayne, NJ (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/024,766

(22) Filed: Dec. 20, 2001

(51) Int. Cl. G06F 17/60

(52) U.S. Cl. 705/64

(57) ABSTRACT

A system and method are disclosed for creating and verifying e-receipts related to e-commerce transactions. The system and method allow consumers and merchants to perform e-transactions using a secure e-receipt system that includes programmable information tags such as Radio frequency identification (RFID) technolog.

### FIELD OF THE INVENTION

The present invention relates generally to the field of e-commerce, and more particularly to a system and method for creating and verifying e-receipts. The system and method allow consumers and merchants to perform e-transactions using a secure e-receipt system that includes programmable information tags such as Radio frequency identification (RFID) technology.

### BACKGROUND OF THE INVENTION

Electronic commerce (e-commerce) is an integrated concept designed to bring together a wide range of business related activities. These activities may include trading support systems for products, services and commodities, ordering and logistic support systems, management and reporting systems, and support systems such as e-mail. E-commerce may generally include any kind of business-related transaction conducted with at least some assistance of electronic tools.

Smart labeling is the latest Radio frequency identification (RFID) technology, combining the advantages of barcode, Electronic Article Surveillance (EAS) and traditional RFID solutions. RFID systems allow for non-contact reading in manufacturing and other types of environments where barcode labels may not perform properly or be practical. RFID has applications in a wide range of markets including automated vehicle identification (AVI) systems and livestock identification because of its capability to track moving objects. The technology has become a primary player in identification, automated data collection, and analysis systems worldwide.

Such systems are designed to serve mass markets with many millions of labels needed per year. For example, Philips Semiconductors' ICODE ICs represent the state-of-the-art in smart label technology, offering a low-cost, re-programmable and disposable solution for source tagging, automatic data capture, theft protection and data storage on a product or its packaging. ICODE smart labels allow almost any item to be tagged for efficient handling. ICODE's highly automated item scanning process does not require line-of-sight and can scan multiple labels at the same time.

ICODE smart labels offer considerable benefits in a broad variety of applications. In airline baggage tagging and parcel services, smart labels offer considerable advantages in sorting and item tracking. In supply chain management systems, smart labels overcome the limitations of barcode technology, providing improved product distribution; and in libraries and rental applications, they provide automated check-in, checkout and inventory control.

As shown in FIG. 1, a conventional RRIF system 10 consists of a tag reader 11, which is connected to a personal computer 12 (PC) through a serial port 13. The PC 12 takes action as it reads the trigger of a tag 14. Information can be exchanged via a communication medium 15 (e.g., Internet or Intranet) with a remote server 16.

The tag reader 11 typically consists of three components:

An antenna or coil;

A transceiver (with decoder); and

A transponder (commonly called an RF tag) that is electronically programmed with unique information.

The antenna emits radio signals to activate the tag and read and write data to it. The antenna is the conduit between the tag and the transceiver. It helps control the system's data acquisition and communication. The electromagnetic fields produced by the antenna can be constantly present or activated as needed when a sensor detects tags.

The data within the RF tag may provide identification for goods in manufacture, in transit or a location. Additional data may be provided for supporting applications through item specific information or instructions immediately available on reading the tag, for example, the color of paint for a car entering a paint sprayer on the production line, or the set-up instructions for a configurable manufacturing apparatus or a shipment manifest.

As discussed above, these conventional systems have many applications, they have typically been used for larger scale applications such as airline baggage reconciliation, postal tracking, road toll management and electronic article surveillance. Such conventional RFID systems are geared to large-scale inventory control or industrial and manufacturing applications. These conventional systems generally lack the flexibility to perform in environments that require with many different inputs (i.e., compatibility) and variations (i.e., flexibility) that are required for general e-commerce applications.

### SUMMARY OF THE INVENTION

One embodiment of the invention is directed to an apparatus including a programmable information tag, a communication unit capable of communicating information to one or more information interfaces, and a controller. The controller receives information from the information interfaces through the communication unit, and programs the programmable information tag with at least part of the information from the information interface. The programmed information relates to a good or service to be provided by a merchant or service provider.

In another embodiment, a system for performing e-commerce transactions is provided. The system includes means for receiving a request to complete a commercial transaction for a good or service over the Internet by a consumer, means for completing the commercial transaction with the consumer and means for providing an e-receipt to the consumer. The e-receipt contains information that may be used by the consumer to program an RFID tag. The system also includes means for recording information related to the commercial transaction and the e-receipt.

Another aspect of the invention relates to an e-commerce method. The method including the steps of receiving a request to complete a commercial transaction for a good or service over the Internet by a consumer, completing the commercial transaction with the consumer and providing an e-receipt to the consumer. The e-receipt contains information that may be used by the consumer to program an RFID tag. The method also includes the step of recording information related to the commercial transaction and the e-receipt.

These and other features and advantages of the present invention will become more apparent from the accompanying drawings and the following detailed description.

### BRIEF DESCRIPTION OF THE DRAWINGS

FIG. 1 shows a conventional RFID system.

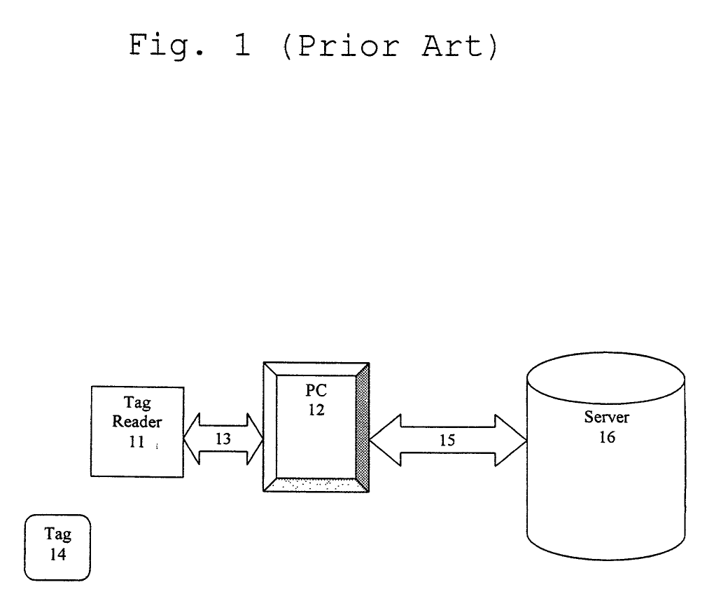

FIG. 2 illustrates the operation of an e-receipt system in accordance with a one embodiment of the invention.

FIG. 3 is a block diagram of an exemplary e-receipt device in accordance with another embodiment of the invention.

### DETAILED DESCRIPTION OF THE INVENTION

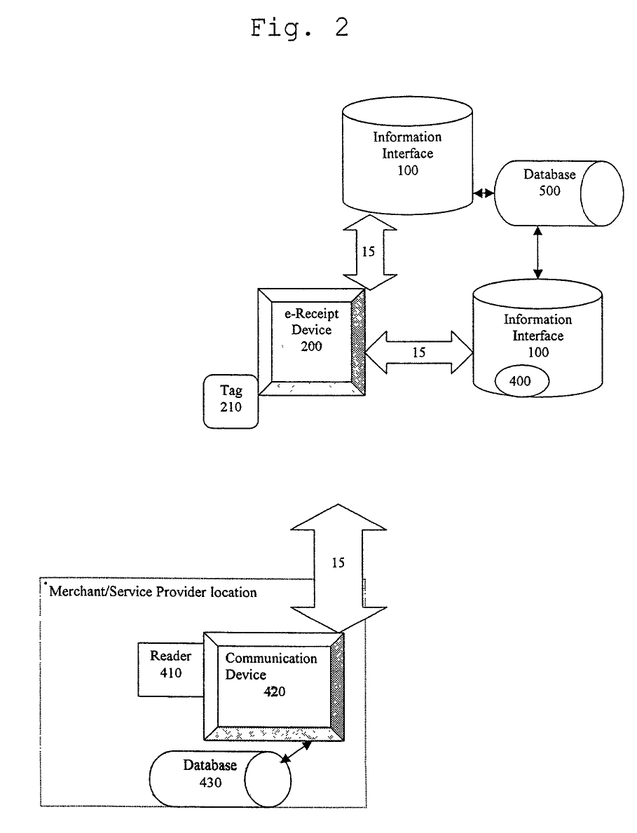

FIG. 2 shows a preferred embodiment of the invention, in which one or more information interfaces 100 interact with onr or more e-receipt devices 200. The information interfaces 100 may be, for example, a web server of a merchant/service provider or an e-commerce processing center for the merchant/service provider. The e-receipt devices 200 may represent a PDA, a laptop computer, a cell phone or similar electronic device. The e-receipt devices 200 also include a programmable RFID tag 210. The RFID tag 210 may be integrated with the e-receipt device 200 or removable.

The e-receipt device 200 can communicate to one or more of the more information interfaces 100 over a network 300. For example, the Internet may be accessed by the e-receipt device 200 through wired connections, wireless connections or combinations thereof, using well-known conventional communication protocols such as the Internet Protocol (IP).

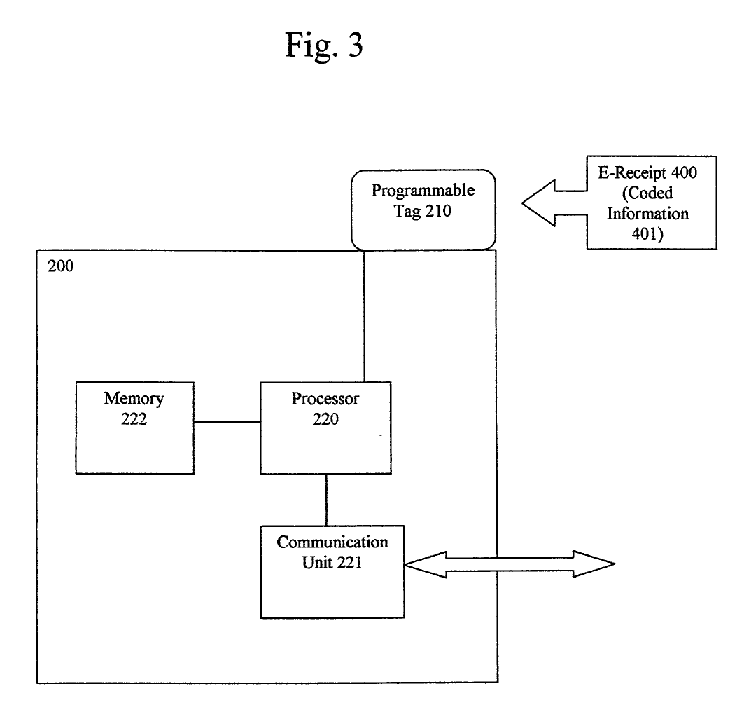

FIG. 3 shows an example of a hardware design of the e-receipt device 200 in accordance with one embodiment of the invention. In this example, the e-receipt device 200 includes a processor 220 and a memory 222. The processor 220 may represent, e.g., a microprocessor, a central processing unit, a computer, a circuit card, an application-specific integrated circuit (ASICs), as well as portions or combinations of these and other types of processing device which already part of the e-receipt device 200 (e.g., CPU for a television set). The memory 222 may represent, e.g., disk-based optical or magnetic storage units, electronic memories, as well as portions or combinations of these and other memory devices.

As shown, the e-receipt device 200 also includes a communication unit 221 (e.g. Ethernet, Bluetooth, cellular or packet data interface) and the programmable RFIF tag 210. Preferably the tag is an RFID-type tag, but other types of programmable tags may be used, e.g., a barcode reader.

In operation, the e-receipt device 200 allows the consumer to make e-commerce transactions and be provided with a secure e-receipt 400. The consumer may initiate the e-transaction in a conventional manner. For example, the consumer may communicate with an online Internet product suppler or service provider, e.g., Amazon.com. The consumer may then complete the online consumer transaction according to the general procedures established by the online vender.

There are numerous e-commerce or e-transactions however that require the consumer to perform some type of personal follow-up. This may be, for example, merchandise pick-up, renting a car, booking a hotel room, attending an entertainment event, etc. The present invention allows the consumer to receive the secure e-receipt 400 that can be verified by the merchant before completion of the transaction. This provides added security to both the consumer and the merchant.

In this regard, after the initial online procedures are completed between the consumer and the online vender, the e-receipt device 200 receives the e-receipt 400 that can be used to verify that the e-transaction is valid and that the holder of the e-receipt 400 should receive the goods/service related to the e-receipt 400. The e-receipt 400 may be formed in part by unique coded information 401. The unique coded information 401 may a randomly generated or predefined number. This information is then programmed into the RFID tag 210 associated with the e-receipt device 200.

At the information interface 100, a database 110 may be maintained that records what goods or service are associated with the e-receipt 400. Additional information may also be recorded such as the consumer identify and e-receipt device 200 identification codes.

In order to collect the goods or obtain the service associated with the e-receipt 400, the consumer merely has to present the e-receipt to the merchant or service provider. The merchant or service provider than automatically reads the RDID tag 210 using an reader 410 and can instantly verify that the holder of the e-receipt 400 should receive the product or service. It should be noted that the RFID tag 210 may be active or passive.

Preferably the reader 410 is also associated with a communication device 420 similar to the e-receipt device 200 and can communicate with the information interfaces 100. A determination is made as to which of the information interfaces 100 is to be contacted. This determination is based upon information received/read from the RFID tag 210. The merchant or service provider then can verify what good or service is to be provided to the holder of the e-receipt 400. For example, the communication device 420 and the information interface 100 exchange information to confirm the e-receipt is valid, the e-receipt device 200 is authorized and what goods and/or services are to be provided.

Alternatively, the merchant or service provider may be periodically notified one or more e-receipts 400 have been issued for goods or service associated with that merchant or service provider. This will enable the merchant or service provider to be ready to provide the good or service without having to contact the information interfaces 100 each time an e-receipt 400 is presented. A database 430 of such downloaded e-receipts 400 may be created by the merchant or service provider.

Preferably, all the e-receipt devices 200 are identified with a unique identification code that is stored in a central database 500. Before the e-receipt 400 information is downloaded into the e-receipt device 200, the identification code is read and checked to make sure that the e-receipt device 200 is authorized and valid. A check may also be performed to determine whether the user is authorized. This may be done, for example, based upon a name associated with a credit card being used or other similar entered information.

In another embodiment, the e-receipts 400 may also be used to automate the processing of the transaction at the merchant or service provider location. For example, the e-receipt 400 may include all information for a hotel guest to check in (i.e., name, address, credit card number, length of stay, etc.). Other similar type applications of the e-receipts 400 include automating a car rental transaction (i.e., the e-receipt 400 information may include the customer's name, credit card number and driver's license number).

In another embodiment, public key cryptography may also to provide added security with the e-receipts 400. In this embodiment, the consumer and the merchant can create a public and private key before the e-transaction. The unique coded information of the e-receipt 400 is coded according to the pubic key cryptography. This public key procedure is well known in the art and will not be discussed in detail herein.

As discussed above, the e-receipt device 200 are preferable used as a security mechanism for e-commerce transactions. Extensible mark-up language (XML) is fast becoming the dominant language for describing content delivered over the Internet. The XML standard describes a class of data objects called XML documents and the behavior of computer programs which process such documents. XML documents are made up of storage units called entities, which contain either parsed or unparsed data. Parsed data is made up of characters, some of which form character data, and some of which form markup. Markup for a given XML document encodes a description of the storage layout and logical structure of that document. XML provides a mechanism to impose constraints on the storage layout and logical structure. Additional details regarding conventional XML may be found in XML 1.0 (Second Edition), World Wide Web Consortium (W3C) Recommendation, October 2000, www. w3.org/TR/REC-xml, which is incorporated by reference herein.

SOAP is a protocol for exchanging information in a distributed, decentralized environment. SOAP is an XML based protocol consisting of: an envelope which defines a means for describing what a message contains and how it is to be processed, encoding rules for expressing application-defined data types, and a convention for representing remote procedure calls and responses. SOAP messages are typically one-way transmissions from a sender to a receiver, but they can be combined to implement patterns such as request/response.

HTTP is a protocol with the lightness and speed necessary for a distributed collaborative hypermedia information system. It is a generic stateless object-oriented protocol, which may be used for many similar tasks such as name servers, and distributed object-oriented systems, by extending the commands, or “methods”, used. A feature if HTTP is the negotiation of data representation, allowing systems to be built independently of the development of new advanced representations.

Sending data over the Internet is typically performed using Transmission Control Protocol/Internet Protocol (TCP/IP), which is composed of layers:

IP - is responsible for moving packet of data from node to
node. IP forwards each packet based on a four-byte destination
address (the IP number) The Internet authorities assign ranges
of numbers to different organizations. The organizations assign
groups of their numbers to departments. IP operates on gateway
machines that move data from department to organization to
region and then around the world.
TCP - is responsible for verifying the correct delivery of data
from client to server. Data can be lost in the intermediate
network. TCP adds support to detect errors or lost data and to
trigger retransmission until the data is correctly and
completely received.
Socket - is a name given to the package of subroutines that
provide access to TCP/IP on most systems.

The e-receipt device 200 also includes a physical layer. A physical layer is concerned with the electrical, mechanical and timing aspects of signal transmission over a communication medium. Any one or more of a variety of well-known layers such as modems, Ethernet, cellular and Bluetooth may be used.

An advantage of the present invention is that a wide variety of system architectures can be used to implement the system of FIG. 2. Server-side and client-side architectures can be used. As briefly mention above, the information interface 100 may be a web server coupled to the device 200 over the Internet or other communication network.

Preferably an XML/SOAP message is sent and received by the device 200 and the information interface 100. This is advantageous because messages can be exchanged efficiently in a distributed, decentralized environment. The XML/SOAP message can be adapted to many different applications. See SOAP: Simple Object Access Protocol Version 1.1 (www.w3.org/TR/SOAP/), which is incorporated by reference herein. Another requirement for module is to create SOAP messages that can be understood by the APACHE-SOAP implementation. This is a very versatile tool for writing XML documents. It is able to make a direct mapping between various data-types and their equivalent representation in SOAP.

The functional operations associated with the device 200, as described above, may be implemented in whole or in part in one or more software programs stored in the memory 222 and executed by the processor 220. The network 300 may represent a global computer communications network such as the Internet, a wide area network, a metropolitan area network, a local area network, a cable network, a satellite network or a telephone network, as well as portions or combinations of these and other types of networks. The information interfaces 100 and the device 200 may themselves be respective server and client machines coupled to the network 300.

While the present invention has been described above in terms of specific embodiments, it is to be understood that the invention is not intended to be confined or limited to the embodiments disclosed herein. On the contrary, the present invention is intended to cover various structures and modifications thereof included within the spirit and scope of the appended claims.

What is claimed is:

1. An apparatus comprising:
a programmable information tag;
a communication unit capable of communicating information to one or more information interfaces; and
a controller, coupled the programmable information tag and the communication unit, arranged to receive information from the information interfaces through the communication unit, and program the programmable information tag with at least part of the information from the information interface,
wherein the programmed information relates to a good or service to be provided by a merchant or service provider.

2. The apparatus according to claim 1, wherein the apparatus and the information interface communicate in a client/server network.

3. The apparatus according to claim 1, wherein the programmable information tag comprises an RFID tag.

4. The apparatus according to claim 1, wherein the programmable information tag comprises a barcode tag.

5. The apparatus according to claim 1, wherein the programmable information tag is detachable from the apparatus.

6. The apparatus according to claim 1, wherein the information comprises a receipt for goods or service purchased via an e-commerce transaction.

7. The apparatus according to claim 2, wherein the client/server network comprises the Internet.

8. The apparatus according to claim 1, wherein the programmed information further includes information related to a particular user.

9. An e-commerce method, comprising the steps of:
receiving a request to complete a commercial transaction for a good or service over the Internet by a consumer;
completing the commercial transaction with the consumer;
providing an e-receipt to the consumer, the e-receipt containing information that may be used by the consumer to program an RFID tag; and
recording information related to the commercial transaction and the e-receipt.

10. The e-commerce method according to claim 9, wherein the information includes a unique code.

11. The e-commerce method according to claim 9, wherein the information includes data related to the consumer's identity.

12. The e-commerce method according to claim 9, further comprising creating a database that includes information that is used to verify what goods or services are associated with the e-receipt.

13. The e-commerce method according to claim 12, wherein the database further includes consumer profiles.

14. A system for performing e-commerce transactions, comprising:
means for receiving a request to complete a commercial transaction for a good or service over the Internet by a consumer;
means for completing the commercial transaction with the consumer;
means for providing an e-receipt to the consumer, the e-receipt containing information that may be used by the consumer to program an RFID tag; and
means for recording information related to the commercial transaction and the e-receipt.

15. The system according to claim 14, wherein the information includes a unique code.

16. The system according to claim 14, wherein the information includes data related to the consumer's identity.

17. The system according to claim 9, further comprising means for creating a database that includes information that is used to verify what goods or services are associated with the e-receipt.

18. The system according to claim 17, wherein the database further includes consumer profiles.
